(19) United States
(12) Patent Application Publication
(10) Pub. No.: US 2024/0414579 A1
(43) Pub. Date: Dec. 12, 2024

(54) MEASUREMENT RELAXATION

(71) Applicant: Nokia Solutions and Networks Oy, Espoo (FI)

(72) Inventors: Qiyang ZHAO, Antony (FR); Hans Thomas HÖHNE, Helsinki (FI); Muhammad Majid BUTT, Naperville, IL (US)

(73) Assignee: Nokia Solutions and Networks Oy, Espoo (FI)

(21) Appl. No.: 18/699,465

(22) PCT Filed: Oct. 19, 2022
(86) PCT No.: PCT/EP2022/079042

§ 371 Date: Apr. 8, 2024

(30) Foreign Application Priority Data
Oct. 20, 2021 (FI) 20216084

(51) Int. Cl. H04W 24/10; H04L 41/147; H04W 36/30

(52) U.S. Cl. CPC H04W 24/10; H04L 41/147; H04W 36/305

(57) ABSTRACT

According to an example embodiment, a network node device is configured to obtain measurement data of radio measurements from at least one client device; detect an outage and/or failure of the at least one client device during a first prediction period; based on the measurement data and the detected outage and/or the detected failure, train a prediction model to predict an outage and/or failure probability during a prediction period from measurement data of radio measurements; and provide the trained prediction model to the at least one client device.

### TECHNICAL FIELD

The present disclosure generally relates to the field of wireless communications. In particular, the present disclosure relates to a network node device, a client device, and related methods and computer programs.

### BACKGROUND

In 5G and beyond wireless communication systems, energy efficiency becomes a key requirement to support a substantial increase in new devices and to reduce the carbon footprint. Maximizing device battery life is important to improve end-user experience of mobile broadband devices and to support low power devices with reduced capability. Radio measurements are used to ensure good client device connectivity in dynamic radio environment, particularly when client mobility is high. However, extra measurements increase client device power consumption. The 5G system introduces massive antennas, beams, small cells, which can significantly increase radio measurement activities to ensure reliable beam and cell level mobility performance.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

An example embodiment of a network node device comprises at least one processor and at least one memory comprising computer program code. The at least one memory and the computer program code are configured to, with the at least one processor, cause the network node device to: obtain measurement data of radio measurements from at least one client device; detect an outage and/or failure of the at least one client device during a first prediction period; based on the measurement data and the detected outage and/or the detected failure, train a prediction model to predict an outage and/or failure probability during a prediction period from measurement data of radio measurements; and provide the trained prediction model to the at least one client device. The network node device can, for example, train the prediction model to predict an outage and/or failure probability from the measurement data.

An example embodiment of a network node device comprises means for performing: obtain measurement data of radio measurements from at least one client device; detect an outage and/or failure of the at least one client device during a first prediction period; based on the measurement data and the detected outage and/or the detected failure, train a prediction model to predict an outage and/or failure probability during a prediction period from measurement data of radio measurements; and provide the trained prediction model to the at least one client device.

In an example embodiment, alternatively or in addition to the above-described example embodiments, the first prediction period is after a first evaluation period during which the radio measurements were performed.

In an example embodiment, alternatively or in addition to the above-described example embodiments, the radio measurements comprise at least a signal-to-interference plus noise ratio and/or a reference signal received power. The network node device can, for example, efficiently utilise the signal-to-interference plus noise ratio and/or the reference signal received power for the training.

In another example embodiment, alternatively or in addition to the above-described example embodiments, the outage and/or failure comprises at least one of: out-of-sync, radio link failure, beam failure and/or handover failure. The network node device can, for example, efficiently train the prediction model to predict out-of-sync, radio link failure, beam failure, and/or handover failure.

In another example embodiment, alternatively or in addition to the above-described example embodiments, the prediction model comprises a machine learning model. The machine learning model may be, for example, especially suitable for predicting the outage and/or failure from the radio measurements.

In another example embodiment, alternatively or in addition to the above-described example embodiments, the measurement data further comprises a serving cell location and/or a serving beam angle associated with the radio measurements. The network node device can, for example, train the prediction model to also utilise the serving cell location and/or a serving beam angle in predicting the outage and/or failure.

In another example embodiment, alternatively or in addition to the above-described example embodiments, the at least one memory and the computer program code are further configured to, with the at least one processor, cause the network node device to: receive an indication from a client device in the at least one client device that an outage and/or failure is going to occur during an upcoming prediction period; and in response to receiving the indication, perform beam and/or mobility management before the upcoming prediction period to avoid the outage and/or failure. The network node device can, for example, proactively perform beam and/or mobility management before the predicted outage and/or failure occurs.

An example embodiment of a client device comprises at least one processor and at least one memory comprising computer program code. The at least one memory and the computer program code are configured to, with the at least one processor, cause the client device to: obtain a trained prediction model configured to predict an outage and/or failure probability during a prediction period from measurement data of radio measurements performed during an evaluation period before the prediction period; obtain measurement data comprising measurement data of radio measurements performed during a first evaluation period; obtain an observed outage and/or failure probability for a first prediction period after the first evaluation period; apply a plurality of relaxation factors to the measurement data corresponding to the first evaluation period, wherein each relaxation factor in the plurality of relaxation factors defines a reduction in a frequency of performing the radio measurements, thus obtaining a plurality of input datasets, wherein each input dataset in the plurality of input datasets corresponds to a relaxation factor in the plurality of relaxation factors; obtain a predicted outage and/or failure probability for the first prediction period for each relaxation factor in the plurality of relaxation factors by feeding each input dataset from the plurality of input datasets into the trained prediction model; obtain a prediction accuracy for each relaxation factor in the plurality of relaxation factors by comparing a corresponding predicted outage and/or failure and the observed outage and/or failure probability; and select a relaxation factor to be used from the plurality of relaxation factor based at least on the prediction accuracy of each relaxation factor. The client device can, for example, utilize the prediction model in order to find a suitable relaxation factor.

An example embodiment of a client device comprises means for performing: obtain a trained prediction model configured to predict an outage and/or failure probability during a prediction period from measurement data of radio measurements performed during an evaluation period before the prediction period; obtain measurement data comprising measurement data of radio measurements performed during a first evaluation period; obtain an observed outage and/or failure probability for a first prediction period after the first evaluation period; apply a plurality of relaxation factors to the measurement data corresponding to the first evaluation period, wherein each relaxation factor in the plurality of relaxation factors defines a reduction in a frequency of performing the radio measurements, thus obtaining a plurality of input datasets, wherein each input dataset in the plurality of input datasets corresponds to a relaxation factor in the plurality of relaxation factors; obtain a predicted outage and/or failure probability for the first prediction period for each relaxation factor in the plurality of relaxation factors by feeding each input dataset from the plurality of input datasets into the trained prediction model; obtain a prediction accuracy for each relaxation factor in the plurality of relaxation factors by comparing a corresponding predicted outage and/or failure and the observed outage and/or failure probability; and select a relaxation factor to be used from the plurality of relaxation factor based at least on the prediction accuracy of each relaxation factor.

In an example embodiment, alternatively or in addition to the above-described example embodiments, the at least one memory and the computer program code are further configured to, with the at least one processor, cause the client device to obtain the prediction accuracy for each relaxation factor by calculating a loss between the corresponding predicted outage and/or failure probability and the observed outage and/or failure probability using a loss function. The client device can, for example, efficiently calculate the prediction accuracy for each relaxation factor.

In another example embodiment, alternatively or in addition to the above-described example embodiments, the at least one memory and the computer program code are further configured to, with the at least one processor, cause the client device to: estimate a client device power consumption for each relaxation factor in the plurality of relaxation factors; and select the used relaxation factor based at least on the estimated client power consumption of each relaxation factor and the prediction accuracy of each relaxation factor. The client device can, for example, take into account both the power consumption and the prediction accuracy when choosing the relaxation factor.

In another example embodiment, alternatively or in addition to the above-described example embodiments, the at least one memory and the computer program code are further configured to, with the at least one processor, cause the client device to obtain trained prediction model by performing: perform radio measurements during a second evaluation period, obtaining measurement data corresponding to the second evaluation period; provide the measurement data corresponding to the second evaluation period to a network node device; and obtain the trained prediction model from the network node device, wherein the prediction model has been trained by the network node device based at least on the measurement data corresponding to the second evaluation period. The client device can, for example, reduce power consumption and/or obtain a more general prediction model by allowing the network node device to train the prediction model.

In another example embodiment, alternatively or in addition to the above-described example embodiments, the at least one memory and the computer program code are further configured to, with the at least one processor, cause the client device to obtain trained prediction model by performing: perform radio measurements during a second evaluation period, obtaining measurement data corresponding to the second evaluation period; detect an outage and/or failure during a second prediction period after the second evaluation period; and based on the measurement data corresponding to the second evaluation period and the detect outage and/or failure during the second prediction period, train the prediction model. The client device can, for example, train the prediction model thus reducing amount of signalling between the client device and the network node device.

In another example embodiment, alternatively or in addition to the above-described example embodiments, the at least one memory and the computer program code are further configured to, with the at least one processor, cause the client device to: perform radio measurements during a third evaluation period, obtaining measurement data corresponding to the third evaluation period; predict an outage and/or failure during a third prediction period, after the third evaluation period, by feeding the measurement data corresponding to the third evaluation period into the trained prediction model; and report the outage and/or failure to a network node device before the outage and/or failure occurs. The client device can, for example, proactively report the outage/failure to the network node device in order to allow the network node device to, for example, perform beam and/or mobility management to avoid the outage and/or failure.

In another example embodiment, alternatively or in addition to the above-described example embodiments, the at least one memory and the computer program code are further configured to, with the at least one processor, cause the client device to: report the outage and/or failure to the network node device before the outage and/or failure occurs in response to a predicted outage and/or failure probability outputted by the trained prediction model, in response to the measurement data corresponding to the third evaluation period, being greater than a preconfigured threshold. The client device can, for example, proactively report the outage/failure to the network node device in response to the outage/failure being highly probable, in order to allow the network node device to, for example, perform beam and/or mobility management to avoid the outage and/or failure.

An example embodiment of a method comprises: obtaining measurement data of radio measurements from at least one client device; detecting an outage and/or failure of the at least one client device during a first prediction period; based on the measurement data and the detected outage and/or the detected failure, training a prediction model to predict an outage and/or failure probability during a prediction period from measurement data of radio measurements; and providing the trained prediction model to the at least one client device.

An example embodiment of a method comprises: obtaining a trained prediction model configured to predict an outage and/or failure probability during a prediction period from measurement data of radio measurements performed during an evaluation period before the prediction period; obtaining measurement data comprising measurement data of radio measurements performed during a first evaluation period; obtaining an observed outage and/or failure probability for a first prediction period after the first evaluation period; applying a plurality of relaxation factors to the measurement data corresponding to the first evaluation period, wherein each relaxation factor in the plurality of relaxation factors defines a reduction in a frequency of performing the radio measurements, thus obtaining a plurality of input datasets, wherein each input dataset in the plurality of input datasets corresponds to a relaxation factor in the plurality of relaxation factors; obtaining a predicted outage and/or failure probability for the first prediction period for each relaxation factor in the plurality of relaxation factors by feeding each input dataset from the plurality of input datasets into the trained prediction model; obtaining a prediction accuracy for each relaxation factor in the plurality of relaxation factors by comparing a corresponding predicted outage and/or failure and the observed outage and/or failure probability; and selecting a relaxation factor to be used from the plurality of relaxation factor based at least on the prediction accuracy of each relaxation factor.

An example embodiment of a computer program product comprises program code configured to perform the method according to any of the above example embodiments, when the computer program product is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example embodiment of the subject matter described herein illustrating a client device;

FIG. 2 illustrates an example embodiment of the subject matter described herein illustrating a client device;

FIG. 3 illustrates an example embodiment of the subject matter described herein illustrating a flow chart of failure prediction and measurement relaxation;

FIG. 4 illustrates an example embodiment of the subject matter described herein illustrating a time series prediction model;

FIG. 5 illustrates subject matter described herein illustrating measurements with measurement relaxation;

FIG. 6 illustrates subject matter described herein illustrating radio link failure declaration;

FIG. 7 illustrates an example embodiment of the subject matter described herein illustrating radio measurement timings with different relaxation factors applied;

FIG. 8 illustrates an example embodiment of the subject matter described herein illustrating a flow chart of prediction model training, failure prediction, and measurement relaxation;

FIG. 9 illustrates an example embodiment of the subject matter described herein illustrating a signalling diagram;

FIG. 10 illustrates a comparative example illustrating out-of-sync detection;

FIG. 11 illustrates an example embodiment of the subject matter described herein illustrating predictive measurement relaxation;

FIG. 12 illustrates an example embodiment of the subject matter described herein illustrating prediction error during training;

FIG. 13 illustrates an example embodiment of the subject matter described herein illustrating prediction error during validation;

FIG. 14 illustrates an example embodiment of the subject matter described herein illustrating percentage of out-of-sync prediction error;

FIG. 15 illustrates an example embodiment of the subject matter described herein illustrating percentage of measurement relaxation;

FIG. 16 illustrates an example embodiment of the subject matter described herein illustrating percentage of out-of-sync declaration error;

FIG. 17 illustrates an example embodiment of the subject matter described herein illustrating percentage of energy saving;

FIG. 18 illustrates an example embodiment of the subject matter described herein illustrating a flow chart representation of a method; and

FIG. 19 illustrates an example embodiment of the subject matter described herein illustrating a flow chart representation of another method.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

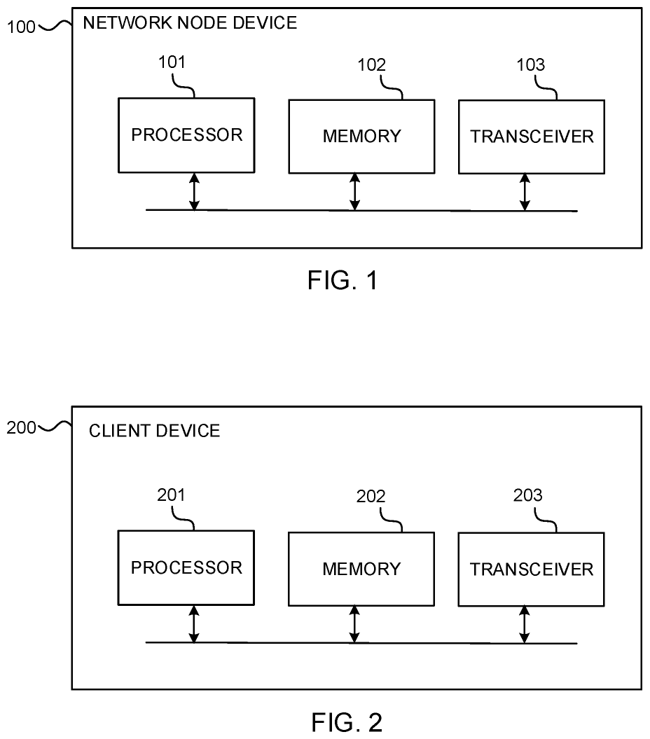

FIG. 1 is a block diagram of a network node device 100 configured in accordance with an example embodiment.

The network node device 100 may comprises one or more processors 101 and one or more memories 102 that comprise computer program code. The network node device 100 may also comprise at least one transceiver 103, as well as other elements, such as an input/output module (not shown in FIG. 1), and/or a communication interface (not shown in FIG. 1).

According to an example embodiment, the at least one memory 102 and the computer program code are configured to, with the at least one processor 101, cause the network node device 100 to obtain measurement data of radio measurements from at least one client device.

The radio measurements may comprise, for example, at least a signal-to-interference plus noise ratio (SINR) and/or a reference signal received power (RSRP).

The network node device 100 may be further configured to detect an outage and/or failure of the at least one client device during a first prediction period.

The first prediction period may be after a first evaluation period during which the radio measurements were performed.

Herein, a period, such as the first evaluation period and the first prediction period, may refer to, for example, any collection of samples, such as measurements. A period may correspond to window and/or a time window or any other collection of samples that many not be limited to a specific time window.

The outage and/or failure may comprise, for example, at least one of: out-of-sync (OOS), radio link failure (RLF) beam failure (BF), and/or handover failure.

The network node device 100 may be further configured to, based on the measurement data and the detected outage and/or the detected failure, train a prediction model to predict an outage and/or failure probability during a prediction period from measurement data of radio measurements.

The network node device 100 may be further configured to, based on the measurement data and the detected outage and/or the detected failure, train a prediction model to predict an outage and/or failure probability during a prediction period from measurement data of radio measurements performed during an evaluation period before the prediction period.

The training may be based on a different data set, which may be partially overlapping. There may be also for instance online training, where the prediction model is updated sequentially with new measurements.

The network node device 100 may train the prediction model using, for example, any machine learning technique, such as supervised learning and/or reinforcement learning.

The prediction model may comprise, for example, a machine learning model, such as a long short-term memory, multi-layer perception (MLP), transformer, or Bayesian Network.

The network node device 100 may collect measurement data and detected outages/failures from a plurality of client devices in varying radio conditions. Thus, the network node device 100 can train the prediction model to predict the outage/failure for client devices in various conditions.

The network node device 100 may be further configured to provide the trained prediction model to the at least one client device.

The network node device 100 may provide the trained prediction model by, for example, providing the model parameters of the trained model.

Although the network node device 100 may be depicted to comprise only one processor 101, the network node device 100 may comprise more processors. In an example embodiment, the memory 102 is capable of storing instructions, such as an operating system and/or various applications.

Furthermore, the processor 101 may be capable of executing the stored instructions. In an example embodiment, the processor 101 may be embodied as a multi-core processor, a single core processor, or a combination of one or more multi-core processors and one or more single core processors. For example, the processor 101 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 101 may be configured to execute hard-coded functionality. In an example embodiment, the processor 101 is embodied as an executor of software instructions, wherein the instructions may specifically configure the processor 101 to perform the algorithms and/or operations described herein when the instructions are executed.

The memory 102 may be embodied as one or more volatile memory devices, one or more non-volatile memory devices, and/or a combination of one or more volatile memory devices and non-volatile memory devices. For example, the memory 102 may be embodied as semiconductor memories (such as mask ROM, PROM (programmable ROM), EPROM (erasable PROM), flash ROM, RAM (random access memory), etc.).

The network node device 100 may be embodied in, for example, a base station (BS). The base station may comprise, for example, a gNodeB (gNB) or any such device providing an air interface for client devices to connect to the wireless network via wireless transmissions.

When the network node device 100 is configured to implement some functionality, some component and/or components of the network node device 100, such as the at least one processor 101 and/or the memory 102, may be configured to implement this functionality. Furthermore, when the at least one processor 101 is configured to implement some functionality, this functionality may be implemented using program code comprised, for example, in the memory 102. For example, if the network node device 100 is configured to perform an operation, the at least one memory 102 and the computer program code can be configured to, with the at least one processor 101, cause the network node device 100 to perform that operation.

Some terminology used herein may follow the naming scheme of 4G or 5G technology in its current form. However, this terminology should not be considered limiting, and the terminology may change over time. Thus, the following discussion regarding any example embodiment may also apply to other technologies.

FIG. 2 is a block diagram of a client device 200 configured in accordance with an example embodiment.

The client device 200 may comprises one or more processors 201 and one or more memories 202 that comprise computer program code. The client device 200 may also comprise at least one transceiver 203, as well as other elements, such as an input/output module (not shown in FIG. 2), and/or a communication interface (not shown in FIG. 2).

According to an example embodiment, the at least one memory 202 and the computer program code are configured to, with the at least one processor 201, cause the client device 200 to obtain a trained prediction model configured to predict an outage and/or failure probability during a prediction period from measurement data of radio measurements performed during an evaluation period before the prediction period.

The client device 200 may be further configured to obtain measurement data comprising measurement data of radio measurements performed during a first evaluation period.

The client device 200 may be further configured to obtain an observed outage and/or failure probability for a first prediction period after the first evaluation period.

The client device 200 may be further configured to apply a plurality of relaxation factors to the measurement data corresponding to the first evaluation period, wherein each relaxation factor in the plurality of relaxation factors defines a reduction in a frequency of performing the radio measurements, thus obtaining a plurality of input datasets, wherein each input dataset in the plurality of input datasets corresponds to a relaxation factor in the plurality of relaxation factors.

The data used by the client device 100 to evaluate the plurality of relaxation factors may be different from the data used to train the prediction model.

The client device 200 may be further configured to obtain a predicted outage and/or failure probability for the first prediction period for each relaxation factor in the plurality of relaxation factors by feeding each input dataset from the plurality of input datasets into the trained prediction model.

The client device 200 may be further configured to obtain a prediction accuracy for each relaxation factor in the plurality of relaxation factors by comparing a corresponding predicted outage and/or failure and the observed outage and/or failure probability.

The client device 200 may be further configured to select a relaxation factor to be used from the plurality of relaxation factor based at least on the prediction accuracy of each relaxation factor.

The client device 200 may be further configured to apply the selected relaxation factor to the measurement periodicity. This may comprise increasing the measurement intervals and/or reducing the measurement samples.

Although the client device 200 may be depicted to comprise only one processor 201, the client device 200 may comprise more processors. In an example embodiment, the memory 202 is capable of storing instructions, such as an operating system and/or various applications.

Furthermore, the processor 201 may be capable of executing the stored instructions. In an example embodiment, the processor 201 may be embodied as a multi-core processor, a single core processor, or a combination of one or more multi-core processors and one or more single core processors. For example, the processor 201 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 201 may be configured to execute hard-coded functionality. In an example embodiment, the processor 201 is embodied as an executor of software instructions, wherein the instructions may specifically configure the processor 201 to perform the algorithms and/or operations described herein when the instructions are executed.

The memory 202 may be embodied as one or more volatile memory devices, one or more non-volatile memory devices, and/or a combination of one or more volatile memory devices and non-volatile memory devices. For example, the memory 202 may be embodied as semiconductor memories (such as mask ROM, PROM (programmable ROM), EPROM (erasable PROM), flash ROM, RAM (random access memory), etc.).

When the client device 200 is configured to implement some functionality, some component and/or components of the client device 200, such as the at least one processor 201 and/or the memory 202, may be configured to implement this functionality. Furthermore, when the at least one processor 201 is configured to implement some functionality, this functionality may be implemented using program code comprised, for example, in the memory 202. For example, if the client device 200 is configured to perform an operation, the at least one memory 202 and the computer program code can be configured to, with the at least one processor 201, cause the client device 200 to perform that operation.

The client device 200 may comprise, for example, a mobile phone, a smartphone, a tablet computer, a smart watch, or any hand-held or portable device or any other apparatus, such as a vehicle, a robot, or a repeater. The client device may also be referred to as a user equipment (UE) or similar.

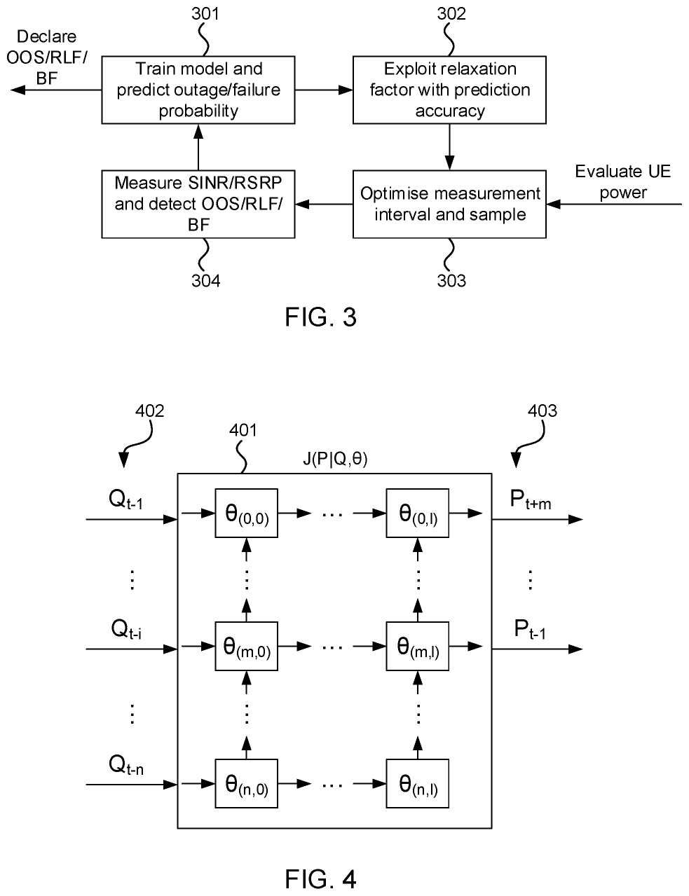

FIG. 3 illustrates an example embodiment of the subject matter described herein illustrating a flow chart of failure prediction and measurement relaxation.

The client device 200 can perform adaptive client measurement relaxation, with proactive outage and failure declaration, using machine learning. This can improve client power saving and mobility performance.

In operation 301, a prediction model can be trained by taking a sequence of radio measurements, such as SINR/RSRP samples, measured by the client device 200 in a past evaluation window. The radio measurements can be associated with the measured (serving) cell 3D location and beam 3D angle. The trained prediction model can approximate the detected OOS, RLF, BF in the next prediction window.

According to an example embodiment, the measurement data further comprises a serving cell location and/or a serving beam angle associated with the radio measurements.

The prediction model can be trained in the network, for example by the network node device 100, or coordinatively between multiple network node devices, such as gNBs. The prediction model can be continuously optimized using measured SINR/RSRP and detected outage/failure reported from a number of client devices 100 under different mobility pattern, speed, and radio environments in the network.

In some example embodiments the network node device 200 may obtain measurement data and use measurement data D1 to update the prediction model. This may also be referred to as “online machine learning”.

The evaluation of the prediction model—predicting a future outage, and/or determining the current accuracy of the model—may still be based on a defined amount of preceding measurement samples D2, where D2 may be overlapping with D1, but need not be identical.

In some example embodiments, the prediction model may be updated continuously. The network node device 200 may obtain measurement data of radio measurements and train the prediction model with that data. The data may be collected in a period. Recent input samples may be used to update the prediction model in a sequential fashion, i.e. online machine learning. A prediction accuracy of the prediction model can be determined for different relaxation factors, using measured data. D2 may come from, for example, a previous measurement period.

In operation 302, the client device 200 can apply the trained prediction model to predict the outage/failure probability and report to the network node device 100 as a reference for proactive beam and mobility management to avoid outage/failure.

The client device 200 can apply different relaxation factors r to the measured SINR/RSRP samples to evaluate the prediction accuracy of the model. The client device 100 can generate a set of measurement input data by, for example, increase the sampling intervals by r times or by reducing the number of samples by r times. The client device 100 can compute prediction errors on the measurement data applied with each different relaxation factors.

According to an example embodiment, the client device 200 is further configured to estimate a client device power consumption for each relaxation factor in the plurality of relaxation factors and select the used relaxation factor based at least on the estimated client power consumption of each relaxation factor and the prediction accuracy of each relaxation factor.

In operation 303, the client device 200 can optimize the measurement interval and sample. The client device 200 can select, for example, a relaxation factor with minimum client device power consumption and minimum degradation to outage/failure declaration. The power consumption on each relaxation factor can be evaluated from the client power saving configurations (i.e. percentage of measurements performed during sleep or active mode, affected by the DRX cycle and packet transmission time). The expected outage/failure declaration error (or delay) can be evaluated from the prediction error of each OOS/RLF/BF occurrence in the next prediction window.

The proactive declaration of OOS, RLF, BF from the client device 200 can allow the network node device 100 to perform effective beam and mobility management in advance to avoid the client device 200 entering poor radio link condition. This can improve mobility performance. The client device 200 can effectively predict outage/failure under different mobility pattern, speed, channel condition, interference etc.

The client device 200 can exploit client measurement relaxation with minimum client device power consumption based on effective prediction of mobility performance, such as OOS, RLF, BF. The client device 200 can further reduce power consumption at low radio link quality and provide adaptive measurement relaxation according to the changing radio environment.

In operation 304, the client device 200 can perform further radio measurements and detect outages/failures. Based on these, the network node device 100 can further train the prediction model and the operations 301-304 can be repeated.

FIG. 4 illustrates an example embodiment of the subject matter described herein illustrating a time series prediction model.

The network node device 100 and/or the client device 200 can train a prediction model to predict the probability of an outage/failure occurring in a future prediction window based on a sequence of client-measured radio measurement samples in a past evaluation window. Each measurement sample can be associated with the measured cell 3D location and/or beam 3D angles. Thus, the samples from different beams and cells can be mixed for input in the case of beam or cell switching performed in the evaluation window. The measurements from multiple neighbouring beams and cells can also be used for input to allow the model to learn the channel characteristics and interference in different network locations and frequencies.

For a given evaluation window with n measurements, a set of input samples at time t can be denoted as (Qₜ₋₁, . . . ,Qₜ₋ₙ). Each sample Q can be a tuple of:

$$Q = \{ s ( r ) , {c}_{x} , {c}_{y} , {c}_{z} , {b}_{a} , {b}_{e} , f \}$$

The SINR s or RSRP r can be measured by the client device 200 on Channel State Information Reference Signal (CSI-RS) or Synchronization Signal Block (SSB) according to the requirement of Radio Link Monitoring (RLM), Beam Failure Detection (BFD), and/or Radio Resource Management (RRM). The gNB 3D location cₓ,c_{y},c_{z}, beam azimuth bₐ and elevation be angle, carrier frequency f can be associated with the measured cell. The input data can thus be a n×7 matrix.

The labelled data used to train the model can be the occurrence of either OOS, RLF, BF in a given prediction window m, which can be declared by the client device 200 based on the duration of SINR or RSRP of a cell or beam lower than Qout, wherein Qout a configured Qout minimum level for SINR. The label data can thus be a m×1 matrix of (Pₜ₊₁, . . . Pₜ₊ₘ).

In the example embodiment of FIG. 4, a time series prediction model 401 is illustrated. The model 401 can learn the dependencies of historical SINR/RSRP variations (Qₜ₋₁, . . . ,Qₜ₋ₙ) 402 over the future outage/failure probability (Pₜ₊₁, . . . Pₜ₊ₘ) 403.

The model 401 can be implemented using, for example, a long short-term memory (LSTM). In the example embodiment of FIG. 4, the model 401 comprises a set of parameters θ_{(i,j)}, associated with each input Qᵢ. The parameters θ_{(i,·)} are multiplied with a weight and added to the later parameters, to capture the time series dependencies. The output layer θ_{(·,l)} is associated with each label Pᵢ.

A loss function can be defined to evaluate the error between the model-predicted outage/failure probability \hat{P} and the detected outage/failure probability P. The loss function may be, for example, of the form:

$$e ( \hat{P} , P ) = \frac{1}{k} {\sum }_{i = 1}^{k} {( {J}_{i} ( \hat{P} \vert Q , θ ) - {P}_{i} )}^{2} .$$

In the training process, an optimization algorithm, such as Stochastic Gradient Descend (SGD), can be applied to tune each parameter θ_{(i,j)}, such that the average prediction error of samples collected from all client devices 200 can be minimized, and the model can be applicable to all measured environments.

The network node device 100 can continuously optimize the model 401 using, for example, SGD with new samples reported by the client device 200. Once the prediction error is sufficiently low (i.e. e<ε), the network node device 100 can send the trained parameter set θ to the client device 200. The client device 200 can use the model 401 to predict the outage/failure probability (Pₜ₊₁, . . . Pₜ₊ₘ), and report to the network if, for example, any of Pᵢ approximates 1, as a proactive declaration of OOS, RLF, BF.

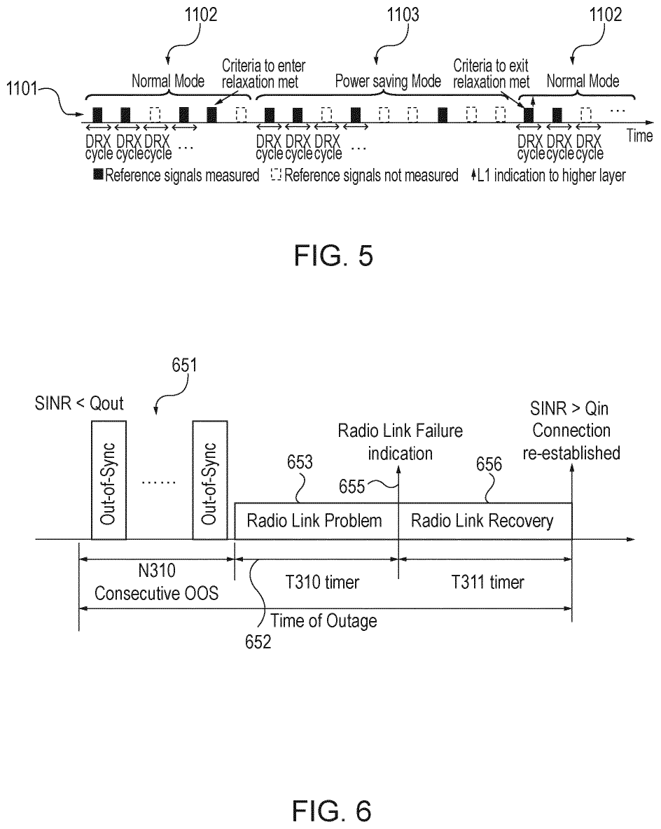

FIG. 5 illustrates subject matter described herein illustrating measurements with measurement relaxation.

Client device measurement relaxation can reduce client device power consumption. It allows the client device 200 to reduce the frequency of measuring radio link quality, on serving and neighbouring cells, such as RSRP, Reference Signal Received Quality (RSRQ), and SINR. Such measurements can be used to assist the following beam and CSI-RS for cell quality. For example, as illustrated in FIG. 5, the frequency of measuring the radio link quality in reduced during a power saving mode 1103 compared to a normal model 1102.

The network node device 100 can broadcast the CSI-RS within DRX ON duration 1101. This can be used in various procedures, such as radio resource management (RRM), to switch UE to better beams and handover to better cells, radio link monitoring (RLM), to ensure good serving cell quality, and beam failure detection (BFD), to maintain good serving beam quality.

In a 5G multi-beam scenario, the client device 200 can perform measurements either using Synchronization Signal Block (SSB) for beam quality, or Channel State Information, and the SSB within SSB Measurement Timing Configuration (SMTC) window, periodically. The client device 200 can be considered to relax some of these measurements if its mobility is low and serving cell radio signal quality is good. The client device 200 can decide to be in sleep mode even when the CSI-RS or SSB are broadcasted, to reduce power consumption. During the power saving mode, the UE is allowed to skip measuring some RS to save power in the sleep mode.

FIG. 6 illustrates subject matter described herein illustrating radio link failure declaration.

One objective of measurement relaxation is to avoid impact on mobility performance, including Radio Link Failure (RLF), Beam Failure (BF), Handover Failure (HOF) monitored by RLM, BFD, RRM measurements, respectively. The procedure of detecting RLF is shown in FIG. 6. The client device 200 can compute an average SINR of a number of samples measured on the RSs. If the SINR is below a configured Qout level, an Out-of-Sync (OOS) can be indicated to the higher layer. If a number of consecutive OOS 651, denoted by N310, is indicated, the client device 200 can enter a T310 timer 652 corresponding to a radio link problem 653. When the T310 timer 652 expires, the client device 200 can report RLF 655 to the network node device 100. The network node device 100 can initiate radio link recovery 656, including beam switching, handover, or RRC connection re-establishment, to improve the radio link quality. Once the SINR is higher than a Qin level, the client device 200 can indicate In-Sync (InS) to the network node device 100 and the time of outage is completed. Qout, Qin, N310, T310 are parameters configured by RRC and are up to operator implementation.

The BF procedure can be similar to RLF, where the measurement is evaluated per beam basis. During radio link recovery, the network node device 100 may perform handover if the client device 100 reports good radio link quality on neighbour cells from RRM measurement. However, the RLM, BFD, RRM procedures may share the measured SINR, RSRP samples to maximize power saving. Under measurement relaxation, the frequency of RRM measurement can also be relaxed, which may cause HOF.

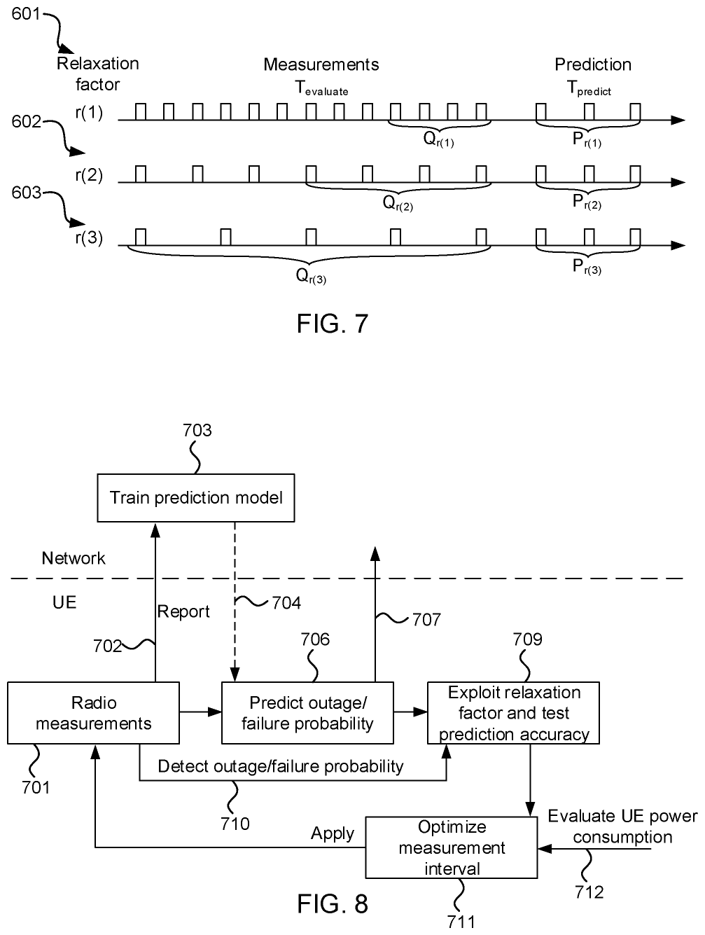

FIG. 7 illustrates an example embodiment of the subject matter described herein illustrating radio measurement timings with different relaxation factors applied.

The client device measurement relaxation can bring power saving by having the client device 200 stay for a longer time in sleep mode. However, measurement relaxation can also cause reduced system performance. First of all, the reduced measurement samples (or pro-longed measurement intervals) can cause error in the SINR/RSRP estimation. This can become more severe if the radio channel has high variation because of client mobility, obstacles, propagation loss and interference.

For example, considering a situation where the SINR is estimated from the past five measurement samples, when applying relaxation factor of two by increasing the measurement interval two times longer, two SINR samples out of five are measured earlier than in the case without measurement relaxation. The estimation error caused by outdated SINR could impact the mobility performance of RLM, BFD, RRM, which monitor the radio link by client measurements.

The client device 200 can, in the procedure of measurement relaxation optimization, apply a relaxation factor exploitation based on evaluation of prediction accuracy. This can allow the client device 200 to exploit the relaxation factor contributing to maximum power saving with minimum impact to outage/failure declaration, according to the current SINR/RSRP pattern.

The impact can be evaluated in the prediction window. The following key performance indicators (KPIs) can be compared to the performance with no relaxation: probability of error outage/failure declarations, delay of outage/failure declarations, and/or prediction error of each outage/failure occurrence. The above tolerated KPI can be defined with respect to different applications. For example, for a client device 200 moving at 30 km/h, a target of 1% of prediction errors may already bring about large measurement savings.

The client device 200 can apply a set of relaxation factors to the radio measurement samples, to create a dataset for testing the prediction accuracy of the prediction model 401.

For a relaxation factor r, the relaxed samples can be, for example, Qᵣ=(Qₜ₋ᵣ, Qₜ₋₂ᵣ, . . . ,Qₜ₋ₙᵣ). Thus, the relaxation factor r can increase measurement interval by r samples. With this approach, the measurement window is extended to nr which captures more sparse and longer radio channel variations. This is illustrated in the example embodiment of FIG. 7 for r=2 and r=3, where the second set of measurements 602 is extended to two times compared to the first set of measurements 601 and the third set of measurements 603 is extended to three times compared to the first set of measurements 601.

Alternatively, the relaxed samples can be, for example, Qᵣ=(Qₜ₋₁, Qₜ₋₂, . . . ,Qₜ−n/r). Thus, the relaxation factor r can reduce the number of measurement samples by r times.

According to an example embodiment, the client device 200 is further configured to obtain the prediction accuracy for each relaxation factor by calculating a loss between the corresponding predicted outage and/or failure probability and the observed outage and/or failure probability using a loss function.

The client device 200 can input each relaxed measurement data set r(i) into the trained model J(P|Q,θ), to compute the predicted outage/failure probability Pᵣ₍ᵢ). The client device 200 can then apply the loss function to compute the prediction error L(Pᵣ₍ᵢ₎,P) under different relaxation factors applied to the measurement samples.

In the relaxation decision phase, the client device 200 can estimate the client device power consumption for each relaxation factor r(i) based on, for example, the overlaps of client measurements and other wake-up occurrence, such as DRX ON duration. The number of missed or delayed declarations of outage/failure can be evaluated on the occurrence of prediction error e>ε within the prediction window. The client device 200 can select the relaxation factor r(i) with minimum client power consumption and occurrence of e>ε. This procedure can be continuously updated on subsequent measurements, such that the relaxation factor is adapted to the changing SINR/RSRP variation in the measurement window.

FIG. 8 illustrates an example embodiment of the subject matter described herein illustrating a flow chart of prediction model training, failure prediction, and measurement relaxation.

The client device 200 can perform radio measurements 701 and report 702 the measurements to the network node device 100.

The implementation of outage/failure prediction and relaxation optimization can be either in the network node device 100, in the client device 200, or in both. For example, in the example embodiment of FIG. 8, the network node device 100 performs the training 703 of the prediction model. The network node device 100 can, for example, collect the SINR/RSRP measurement samples and declared OOS, RLF, BF periodically from connected client devices 200. The network node device 100 can then perform the training procedure to optimize the prediction accuracy of the prediction model in different radio environments. Once the prediction error is minimized, the network node device 100 can update the model parameters 704 to the client devices 200.

According to an example embodiment, the client device 200 is further configured to perform radio measurements during a second evaluation period, obtaining measurement data corresponding to the second evaluation period, provide the measurement data corresponding to the second evaluation period to a network node device, and obtain the trained prediction model from the network node device, wherein the prediction model has been trained by the network node device based at least on the measurement data corresponding to the second evaluation period.

Alternatively, the prediction model may be trained by the client device 200. According to an example embodiment, the client device 200 is further configured to perform radio measurements during a second evaluation period, obtaining measurement data corresponding to the second evaluation period, detect an outage and/or failure during a second prediction period after the second evaluation period, and based on the measurement data corresponding to the second evaluation period and the detect outage and/or failure during the second prediction period, train the prediction model.

According to an example embodiment, the client device 200 is further configured to perform radio measurements during a third evaluation period, obtaining measurement data corresponding to the third evaluation period, predict an outage and/or failure during a third prediction period, after the third evaluation period, by feeding the measurement data corresponding to the third evaluation period into the trained prediction model, and report the outage and/or failure to a network node device before the outage and/or failure occurs.

The selected relaxation factor may be applied during the third evaluation period.

According to an example embodiment, the client device 200 is further configured to report the outage and/or failure to the network node device before the outage and/or failure occurs in response to a predicted outage and/or failure probability outputted by the trained prediction model, in response to the measurement data corresponding to the third evaluation period, being greater than a preconfigured threshold.

The client device 200 can use the trained model to predict 706 the outage/failure occurrence. If the prediction error converges to sufficiently low, and the predicted probability approximates 1, the client device 200 can report 707 the occurrence of OOS, RLF, BF to the network node device 100. The network node device 100 may trigger beam or cell switch proactively to avoid the future outage/failure.

According to an example embodiment, the network node device 100 is further configured to receive an indication from a client device in the at least one client device that an outage and/or failure is going to occur during an upcoming prediction period and, in response to receiving the indication, perform beam and/or mobility management before the upcoming prediction period to avoid the outage and/or failure.

The client device 200 can apply different relaxation factors to the measured SINR/RSRP samples and test the prediction accuracy 709 according to the detected outage/failure. The client device 200 can also evaluate power consumption 712 of each relaxation factor and optimize 711 the measurement interval by selecting the best relaxation factor with, for example, minimum error or delayed declaration of OOS, RLF, BF using the prediction model.

Alternatively, the prediction model may be trained by the client device 200.

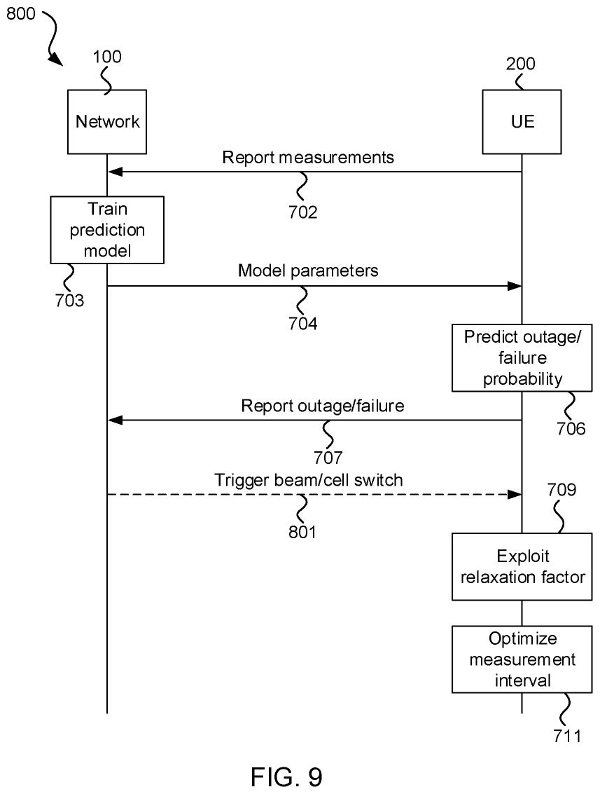

FIG. 9 illustrates an example embodiment of the subject matter described herein illustrating a signalling diagram.

Similarly, to the example embodiment of FIG. 8, the client device 200 can report radio measurements 702 to the network node device 100. The network node device can train 703 the prediction model based on the measurements and provide the model parameters 704 to the client device 200. The client device 200 can then predict 706 an outage/failure based on the trained model and report the outage/failure 707 to the network node device 100.

In response to the outage/failure report 707, the network node device can trigger beam/cell switching 801 in order to avoid the future outage/failure. The client device 200 can apply different relaxation factors to the measured SINR/RSRP samples and test the prediction accuracy 709 according to the detected outage/failure. The client device 200 can optimize 711 the measurement interval by selecting the best relaxation factor with, for example, minimum error or delayed declaration of OOS, RLF, BF using the prediction model. The client device 200 can perform relaxation factor exploration by testing outage/failure prediction accuracy and decide measurement relaxation with minimum power consumption and declaration error (delay).

Alternatively, network node device 100 can exploit the relaxation factor by testing prediction accuracy and optimize measurement periodicity. The network node device 100 can have measurement samples with different periodicities collected from the client devices 200. The network node device 100 can exploit potential better relaxation factors, especially when the client device 200 has no available samples on some measurement periodicity. The network node device 100 may require more frequent measurement and declaration report from the client device 200, which can increase the signalling load.

Alternatively, the client device 200 can train the prediction model. The report of measured SINR/RSRP and detected outage/failure 707 may not be necessary as the samples are available at the client device 200. The network node device 100 may collect the model parameters from all client devices 200, generate a combined model using, for example, federated learning and update the model to all client devices 200. This can reduce signalling load of measurement data but still keep the model generic to different environments. However, a lower prediction accuracy and power saving may be expected because of limited exploration of measured samples and exploitation of relaxation factors on a single client device 200.

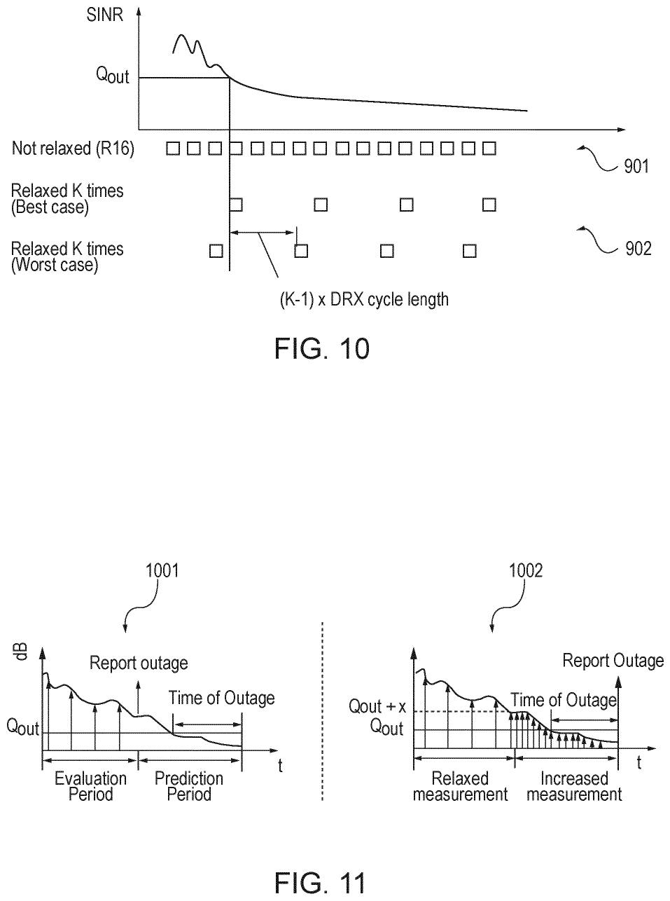

FIG. 10 illustrates a comparative example illustrating out-of-sync detection.

The SINR/RSPR measurements can be used to detect if the client device 200 is in outage or failure. The measurement relaxation can cause delays to identify OOS, declare RLF/BF, and trigger radio link recovery if the SINR drops below Qout as can be seen by comparing the non-relaxed measurements 901 and the relaxed measurements 902 in FIG. 10. The client device 200 could stay for longer time in poor radio link quality, in a poor beam and cell because of delays in beam and cell switching. If the SINR drops below Qout when the measurement is relaxed, the delayed OOS indication until next measurement causes increased time of outage. This can ultimately cause increased probability of RLF/BF.

Thus, the client device 200 may mitigate the drawbacks of measurement relaxation discussed above via the relaxation factor selection disclosed herein.

FIG. 11 illustrates an example embodiment of the subject matter described herein illustrating predictive measurement relaxation.

The client device 200 can perform adaptive control of measurement relaxation and periodicity based on its impact to the mobility performance. The client device 200 can exploit the maximum relaxation factor and adapt dynamically to the changing SINR/RSRP pattern, instead of fixed relaxation criteria and factor which is inflexible.

At least in some example embodiments, reduced measurement activities and/or power consumption can be achieved when outage/failure is predictable.

As an example illustrated in FIG. 11, when SINR drops below Qout, the client device 200 can predict the outage with sparse measurements as illustrated in the case 1001 on the left, while in the comparative case 1002 on the right, the client device 200 should increase measurements to detect the duration of the outage.

The client device 200 can proactively report a future outage/failure occurrence to the network node device 100. The network node device 100 can perform beam or cell switch in advance in order to avoid RLF/BF. As illustrated in FIG. 11, the client device 100 can report the outage based on the prediction model before SINR drops below Qout. The comparative example on the right can report only after the outage is detected, which can reduce mobility performance.

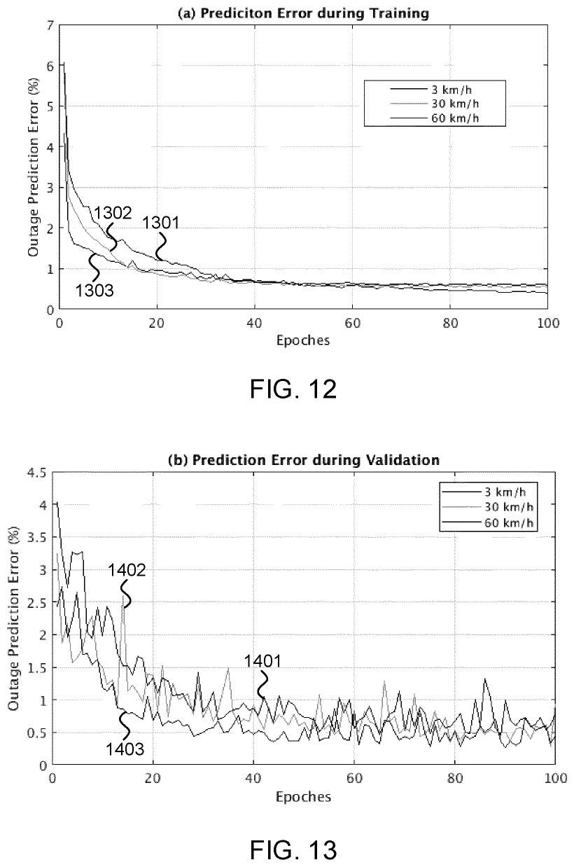

FIG. 12 illustrates an example embodiment of the subject matter described herein illustrating prediction error during training.

Curve 1301 corresponds to a speed of 60 km/h, curve 1302 corresponds to a speed of 30 km/h, and curve 1303 corresponds to a speed of 3 km/h.

The performance was evaluate using a comprehensive system level simulation in a mobility scenario with multi-beams. The parameters are configured with the 3GPP RAN4 study on measurement relaxations. There are 21 cells in FR1 frequency with 8 beams on each. The clients are moving randomly at a speed of 3, 30, or 60 km/h. The FTP3 traffic is applied with 50 ms inter-arrival time, and 40 ms DRX cycles. The initial measurement periodicity is 40 ms, 5 samples.

Data logs of measured SINR samples Q and detected outage occurrence P were extracted from a base-line simulation without measurement relaxation. Measurement window of 10 samples, and prediction window of 1 sample was applied. A 2 layer LSTM model is implemented and trained from around 80,000 samples in 50s simulation time collected by all clients. The model is validated by clients on separated set of samples.

The performance of prediction error during training and validation is shown in FIG. 10. It can be observed that both procedures converge to 0.5% prediction error after 40 epoches of optimization. The convergence is slightly faster on the samples from low-speed clients. This is because the SINR variation is more stable in such scenario, the prediction of outage performs better. However, the model performs very effectively on clients with different speeds.

FIG. 13 illustrates an example embodiment of the subject matter described herein illustrating prediction error during validation.

Curve 1401 corresponds to a speed of 60 km/h, curve 1402 corresponds to a speed of 30 km/h, and curve 1403 corresponds to a speed of 3 km/h.

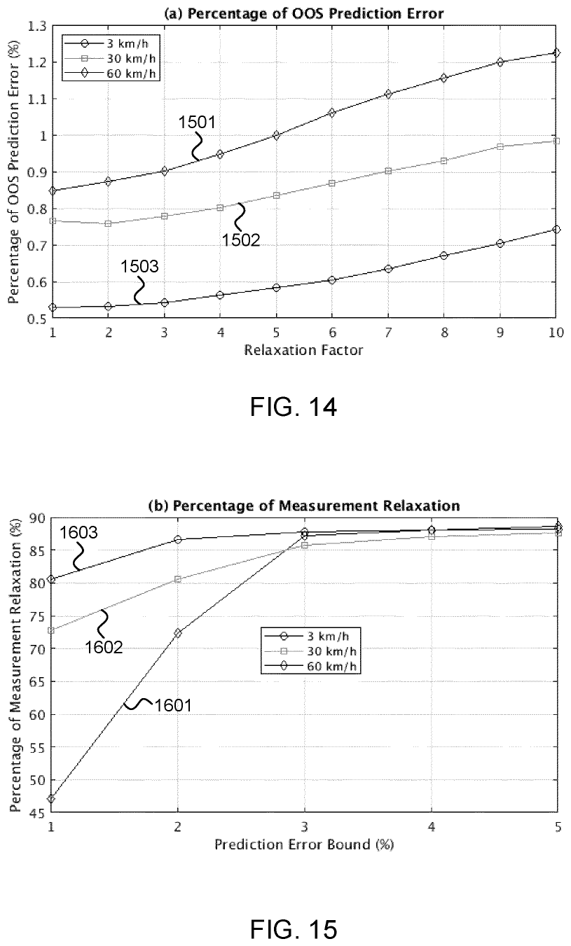

FIG. 14 illustrates an example embodiment of the subject matter described herein illustrating percentage of out-of-sync prediction error.

The performance of the prediction error with different relaxation factor applied to the measured samples is shown in FIG. 14. Curve 1501 corresponds to a speed of 60 km/h, curve 1502 corresponds to a speed of 30 km/h, and curve 1503 corresponds to a speed of 3 km/h.

An increased prediction error of OOS up to 0.4% is seen in FIG. 14 with increased relaxation factor to 10. This is more significant at higher speeds due to faster SINR variations.

FIG. 15 illustrates an example embodiment of the subject matter described herein illustrating percentage of measurement relaxation.

The percentage of the measurement relaxation with different for different prediction error bounds is shown in FIG. 15. Curve 1601 corresponds to a speed of 60 km/h, curve 1602 corresponds to a speed of 30 km/h, and curve 1603 corresponds to a speed of 3 km/h.

It can be observed that the amount of client measurement is reduced from 45% to 88%, with the prediction error increasing from 1% to 3%. At low speeds, a higher measurement relaxation is achieved because of a lower prediction error.

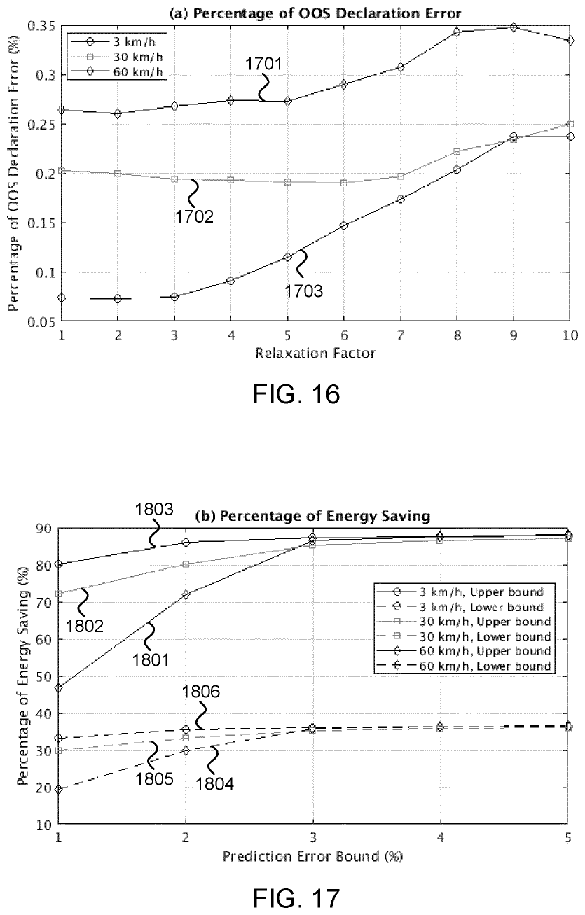

FIG. 16 illustrates an example embodiment of the subject matter described herein illustrating percentage of out-of-sync declaration error.

Curve 1701 corresponds to a speed of 60 km/h, curve 1702 corresponds to a speed of 30 km/h, and curve 1703 corresponds to a speed of 3 km/h.

The corresponding OOS declaration error is shown in FIG. 16 and percentage of energy saving is shown in FIG. 17. The declaration error is computed as the predicted OOS probability <0.5 while the actual OOS is 1. It can be seen from FIG. 16 that the increase in OOS declaration error compared to no relaxation is very low for relaxation up to factor 4 at 3 km/h, factor 7 at 30 km/h, and factor 5 at 60 km/h.

FIG. 17 illustrates an example embodiment of the subject matter described herein illustrating percentage of energy saving.

Curve 1801 corresponds to an upper bound at a speed of 60 km/h, curve 1802 corresponds to an upper bound at a speed of 30 km/h, and curve 1803 corresponds to an upper bound at a speed of 3 km/h. Curve 1804 corresponds to a lower bound at a speed of 60 km/h, curve 1805 corresponds to a lower bound at a speed of 30 km/h, and curve 1806 corresponds to a lower bound at a speed of 3 km/h.

In the total energy saving, taking into account the UE in active or sleep mode, it can be seen that the upper bound is similar to the percentage of relaxed measurement, while the lower bound is from 20% to 38% with prediction error bound below 3%.

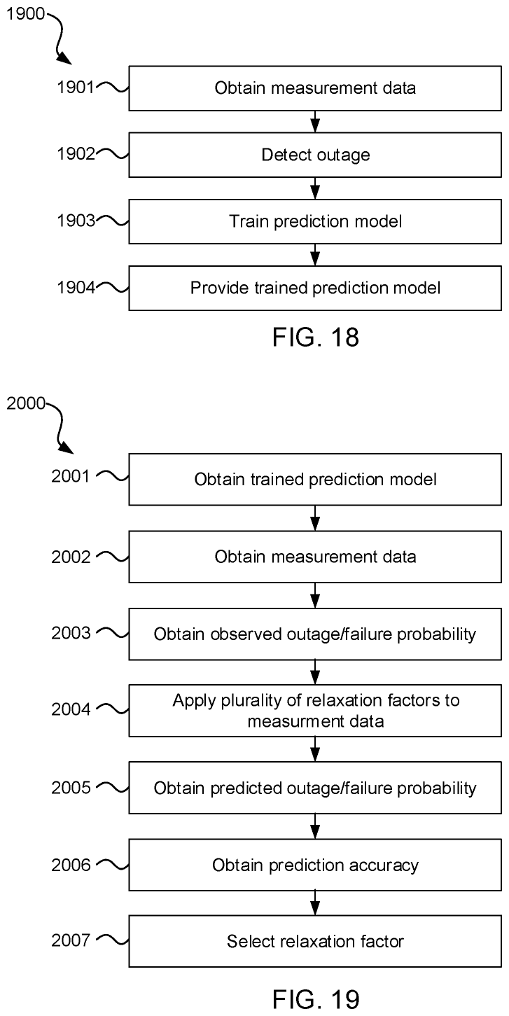

FIG. 18 illustrates an example embodiment of the subject matter described herein illustrating a flow chart representation of a method.

According to an example embodiment, the method 1900 comprises obtaining 1901 measurement data of radio measurements from at least one client device.

The method 1900 may further comprise detecting 1902 an outage and/or failure of the at least one client device during a first prediction period.

The method 1900 may further comprise, based on the measurement data and the detected outage and/or the detected failure, training 1903 a prediction model to predict an outage and/or failure probability during a prediction period from measurement data of radio measurements.

The method 1900 may further comprise providing 1904 the trained prediction model to the at least one client device.

The method 1900 may be performed by, for example, the network node device 100.

FIG. 19 illustrates an example embodiment of the subject matter described herein illustrating a flow chart representation of another method.

According to an example embodiment, the method 2000 comprises obtaining 2001 a trained prediction model configured to predict an outage and/or failure probability during a prediction period from measurement data of radio measurements performed during an evaluation period before the prediction period.

The method 2000 may further comprise obtaining 2002 measurement data comprising measurement data of radio measurements performed during a first evaluation period.

The method 2000 may further comprise obtaining 2003 an observed outage and/or failure probability for a first prediction period after the first evaluation period.

The method 2000 may further comprise applying 2004 a plurality of relaxation factors to the measurement data corresponding to the first evaluation period, wherein each relaxation factor in the plurality of relaxation factors defines a reduction in a frequency of performing the radio measurements, thus obtaining a plurality of input datasets, wherein each input dataset in the plurality of input datasets corresponds to a relaxation factor in the plurality of relaxation factors.

The method 2000 may further comprise obtaining 2005 a predicted outage and/or failure probability for the first prediction period for each relaxation factor in the plurality of relaxation factors by feeding each input dataset from the plurality of input datasets into the trained prediction model.

The method 2000 may further comprise obtaining 2006 a prediction accuracy for each relaxation factor in the plurality of relaxation factors by comparing a corresponding predicted outage and/or failure and the observed outage and/or failure probability.

The method 2000 may further comprise selecting 2007 a relaxation factor to be used from the plurality of relaxation factor based at least on the prediction accuracy of each relaxation factor.

The method 2000 may be performed by, for example, the client device 200.

An apparatus may comprise means for performing any aspect of the method(s) described herein. According to an example embodiment, the means comprises at least one processor, and memory comprising program code, the at least one processor, and program code configured to, when executed by the at least one processor, cause performance of any aspect of the method.

The functionality described herein can be performed, at least in part, by one or more computer program product components such as software components. According to an example embodiment, the network node device 100 comprises a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed example embodiments without departing from the spirit or scope of this specification.

1. A network node device, comprising:
at least one processor; and
at least one memory including computer program code;
the at least one memory and the computer program code configured to, with the at least one processor, cause the network node device to;
obtain measurement data of radio measurements from at least one client device;
detect an outage and/or failure of the at least one client device during a first prediction period;
based on the measurement data and the detected outage and/or the detected failure, train a prediction model to predict an outage and/or failure probability during a prediction period from measurement data of radio measurements; and
provide the trained prediction model to the at least one client device.

2. The network node device according to claim 1, wherein the first prediction period is after a first evaluation period during which the radio measurements were performed.

3. The network node device according to claim 1, wherein the radio measurements comprise at least a signal-to-interference plus noise ratio and/or a reference signal received power.

4. The network node device according to claim 1, wherein the outage and/or failure comprises at least one of: out-of-sync, radio link failure beam failure, and/or handover failure.

5. The network node device according to claim 1, wherein the prediction model comprises a machine learning model.

6. The network node device according to claim 1, wherein the measurement data further comprises a serving cell location and/or a serving beam angle associated with the radio measurements.

7. The network node device according to claim 1, wherein the at least one memory and the computer program code are further configured to, with the at least one processor, cause the network node device:
receive an indication from a client device in the at least one client device that an outage and/or failure is going to occur during an upcoming prediction period; and
in response to receiving the indication, perform beam and/or mobility management before the upcoming prediction period to avoid the outage and/or failure.

8. A client devices, comprising:
at least one processor; and
at least one memory including computer program code;
the at least one memory and the computer program code configured to, with the at least one processor, cause the client device to,
obtain a trained prediction model configured to predict an outage and/or failure probability during a prediction period from measurement data of radio measurements performed during an evaluation period before the prediction period;
obtain measurement data comprising measurement data of radio measurements performed during a first evaluation period;
obtain an observed outage and/or failure probability for a first prediction period after the first evaluation period;
apply a plurality of relaxation factors to the measurement data corresponding to the first evaluation period, wherein each relaxation factor in the plurality of relaxation factors defines a reduction in a frequency of performing the radio measurements, thus obtaining a plurality of input datasets, wherein each input dataset in the plurality of input datasets corresponds to a relaxation factor in the plurality of relaxation factors;
obtain a predicted outage and/or failure probability for the first prediction period for each relaxation factor in the plurality of relaxation factors by feeding each input dataset from the plurality of input datasets into the trained prediction model;
obtain a prediction accuracy for each relaxation factor in the plurality of relaxation factors by comparing a corresponding predicted outage and/or failure and the observed outage and/or failure probability; and
select a relaxation factor to be used from the plurality of relaxation factor based at least on the prediction accuracy of each relaxation factor.

9. The client device according to claim 8, wherein the at least one memory and the computer program code are further configured to, with the at least one processor, cause the client device to obtain the prediction accuracy for each relaxation factor by calculating a loss between the corresponding predicted outage and/or failure probability and the observed outage and/or failure probability using a loss function.

10. The client device according to claim 8, wherein the at least one memory and the computer program code are further configured to, with the at least one processor, cause the client device to:
estimate a client device power consumption for each relaxation factor in the plurality of relaxation factors; and
select the used relaxation factor based at least on the estimated client power consumption of each relaxation factor and the prediction accuracy of each relaxation factor.

11. The client device according to claim 8, wherein the at least one memory and the computer program code are further configured to, with the at least one processor, cause the client device to obtain trained prediction model by performing:
perform radio measurements during a second evaluation period, obtaining measurement data corresponding to the second evaluation period;
provide the measurement data corresponding to the second evaluation period to a network node device; and
obtain the trained prediction model from the network node device, wherein the prediction model has been trained by the network node device based at least on the measurement data corresponding to the second evaluation period.

12. The client device according to claim 8, wherein the at least one memory and the computer program code are further configured to, with the at least one processor, cause the client device to obtain trained prediction model by performing:
perform radio measurements during a second evaluation period, obtaining measurement data corresponding to the second evaluation period;
detect an outage and/or failure during a second prediction period after the second evaluation period; and
based on the measurement data corresponding to the second evaluation period and the detect outage and/or failure during the second prediction period, train the prediction model.

13. The client device according to claim 8, wherein the at least one memory and the computer program code are further configured to, with the at least one processor, cause the client device to:
perform radio measurements during a third evaluation period, obtaining measurement data corresponding to the third evaluation period;
predict an outage and/or failure during a third prediction period, after the third evaluation period, by feeding the measurement data corresponding to the third evaluation period into the trained prediction model; and
report the outage and/or failure to a network node device before the outage and/or failure occurs.

14. The client device according to claim 13, wherein the at least one memory and the computer program code are further configured to, with the at least one processor, cause the client device to:
report the outage and/or failure to the network node device before the outage and/or failure occurs in response to a predicted outage and/or failure probability outputted by the trained prediction model, in response to the measurement data corresponding to the third evaluation period, being greater than a preconfigured threshold.

15. A method, comprising:
obtaining measurement data of radio measurements from at least one client device;
detecting an outage and/or failure of the at least one client device during a first prediction period;
based on the measurement data and the detected outage and/or the detected failure, training a prediction model to predict an outage and/or failure probability during a prediction period from measurement data of radio measurements; and
providing the trained prediction model to the at least one client device.

16. A method, comprising:
obtaining a trained prediction model configured to predict an outage and/or failure probability during a prediction period from measurement data of radio measurements performed during an evaluation period before the prediction period;
obtaining measurement data comprising measurement data of radio measurements performed during a first evaluation period;
obtaining an observed outage and/or failure probability for a first prediction period after the first evaluation period;
applying a plurality of relaxation factors to the measurement data corresponding to the first evaluation period, wherein each relaxation factor in the plurality of relaxation factors defines a reduction in a frequency of performing the radio measurements, thus obtaining a plurality of input datasets, wherein each input dataset in the plurality of input datasets corresponds to a relaxation factor in the plurality of relaxation factors;
obtaining a predicted outage and/or failure probability for the first prediction period for each relaxation factor in the plurality of relaxation factors by feeding each input dataset from the plurality of input datasets into the trained prediction model;
obtaining a prediction accuracy for each relaxation factor in the plurality of relaxation factors by comparing a corresponding predicted outage and/or failure and the observed outage and/or failure probability; and
selecting a relaxation factor to be used from the plurality of relaxation factor based at least on the prediction accuracy of each relaxation factor.

17. A computer program product comprising program code configured to perform the method according to claim 15 when the computer program product is executed on a computer.
